(19) United States
(12) Patent Application Publication
(10) Pub. No.: US 2026/0070740 A1
(43) Pub. Date: Mar. 12, 2026

(54) A Conveyor System for Transporting Items from a Receiving Section to an Outlet Section

(71) Applicant: OPTIMUS SORTER HOLDING B.V., Beuningen (NL)

(72) Inventors: Albertus Cornelis Hendriks, Beuningen (NL); Mike Alexander Hermanus Bender, Nijmegen (NL)

(73) Assignee: OPTIMUS SORTER HOLDING B.V., Beuningen (NL)

(21) Appl. No.: 19/107,733

(22) PCT Filed: Aug. 29, 2023
(86) PCT No.: PCT/NL2023/050439

§ 371 Date: Feb. 28, 2025

(30) Foreign Application Priority Data
Aug. 31, 2022 (NL) 2032901

(51) Int. Cl. B65G 19/02; B65G 19/18; B65G 19/20; B65G 47/46; B65G 47/82

(52) U.S. Cl. CPC B65G 19/02; B65G 19/185; B65G 19/205; B65G 47/46; B65G 47/82

(57) ABSTRACT

A conveyor system for transporting items from a receiving section to an outlet section includes a plurality of assemblies for carrying and transporting the items and a driving system. The driving system is configured to move the plurality of support assemblies from the receiving section to the outlet section. The driving system includes an endless chain of concatenated riving rods that are mutually hingedly connected, and an actuator for moving the endless chain of driving rods. Each support assembly is connected to a respective rod to be moved thereby in the transport direction. The actuator has a frame with two wheels that engage with the endless chain of concatenated rods. One of the wheels is a driving wheel driven by a motor. The actuator with the frame and wheels is mounted to the conveyor system such that it is movable substantially transversely to the transport direction.

### CROSS-REFERENCES TO RELATED APPLICATIONS

This Non-Provisional Patent Application claims the benefit of and priority to PCT Application Serial No. PCT/NL2023/050439, filed Aug. 29, 2023, entitled “A Conveyor System for Transporting Items from a Receiving Section to an Outlet Section,” which claims the benefit of and priority to Netherlands Patent Application Serial No. NL 2032921, filed Aug. 31, 2022, entitled “A Conveyor System for Transporting Items from a Receiving Section to an Outlet Section,” the entire contents of both applications of which are hereby incorporated herein by reference.

### BACKGROUND

A conveyor system is disclosed in WO 2015/133399 A1, and is sold by Optimus Sorters under the trademark OptiSorter™. The system may comprise multiple actuators at different locations of along the guiding rail. A problem with said system is that due to the combination of:
1) the hinge shafts of the rods being mounted in the guiding rail with restricted lateral movement; and
2) the actuator which engages said rods being mounted on said guiding rail
high shear forces may occur when the rods move along the rail, which may cause wear and failure of the conveyor system. The invention aims at an improved conveyor system.

### SUMMARY

The present invention relates to a conveyor system for transporting items from a receiving section to an outlet section, the conveyor system comprising:
an endless guiding rail which extends in a transport direction;
a plurality of support assemblies for carrying and transporting the items along said guiding rail;
a driving system for moving said plurality of support assemblies in said transport direction from the receiving section to the outlet section, wherein said driving system comprises:
   an endless chain of concatenated driving rods which are hingably connected by means of a hings shaft, and the hinge shaft between each pair of driving rods is mounted to said guiding rail in such a manner that said hinge shafts are allowed to move along said guiding rail and lateral movement of said hings shafts with respect to the guiding rail is restricted;
wherein each support assembly is connected to a respective rod to be moved thereby in the transport direction; and
   an actuator connected to the guiding rail for moving said endless chain of concatenated driving rods in the transport direction, wherein said actuator comprises a frame with two wheels which engage said endless chain of concatenated driving rods between them, and wherein one of said wheels is a driving wheel driven by a motor.

A conveyor system according to the preamble is characterized in that said actuator comprising the frame and the wheels is mounted to the conveyor system in such a manner that it is movable substantially transversely to the transport direction.

Preferably, the frame is connected to a link member which extends from said frame 200 substantially parallel to the transport direction, and the outer end of said link member is connected to the conveyor system by means of a pivot member, such that the link member with the actuator can pivot about a pivot axis which is parallel to the axis of rotation of the driving wheel.

Preferably, said pivot member is mounted on said guiding rail.

Preferably, the hinge shaft between each pair of driving rods is mounted to the first guiding rail at the bottom side of the first guiding rail.

Preferably, the top end of each hinge shaft between each pair of driving rods engage the guiding rail by means of guide wheels in an elongated profiled recess of the guiding rail.

Preferably, a guide wheel is coaxially mounted on the hinge shaft and a pair of respective guide surfaces of the profiled recess prevent horizontal lateral movement of the hinge shaft.

Preferably, the pivot member is mounted on top of the guiding rail.

Preferably, the movable actuator comprises the motor.

Preferably, the support assemblies each comprise a tray and a pusher element arranged on said tray to push items from the tray to the outlet section.

### BRIEF DESCRIPTION OF THE DRAWINGS

The present invention will now be illustrated with reference to the drawing where

FIG. 1 shows a perspective view of a conveyor system;

FIG. 2A shows a perspective top front view of a drive system for the conveyor system according to the invention;

FIG. 2B shows a perspective bottom front view of the drive system;

FIG. 3A shows a front view of the drive system;

FIG. 3B shows a top view of the drive system;

FIG. 3C shows a longitudinal cross section of the drive system; and

FIG. 3D shows a cross section of the drive system.

### DETAILED DESCRIPTION

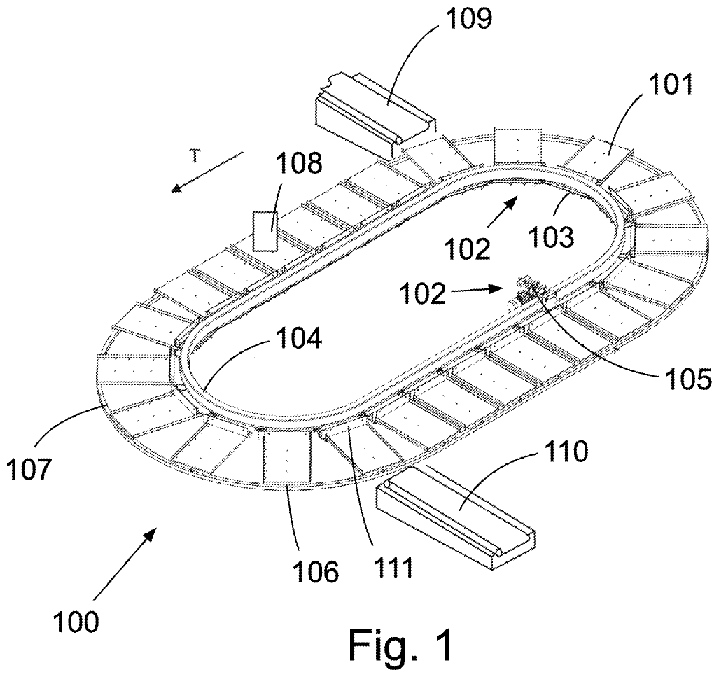

FIG. 1 shows a conveyor system 100. The conveyor system 100 comprises a plurality of guided support assemblies 101, in the form of trays, for carrying and transporting items 108, and a driving system 102.

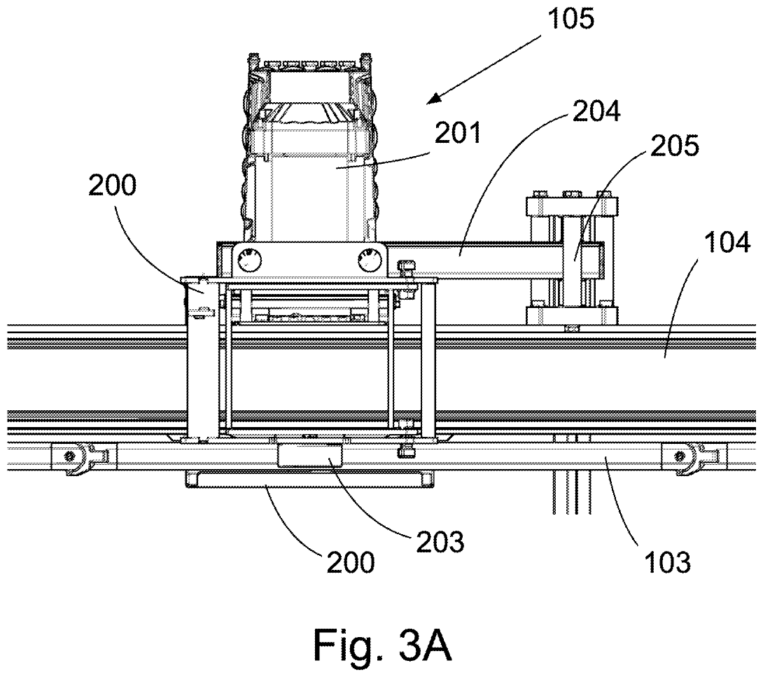

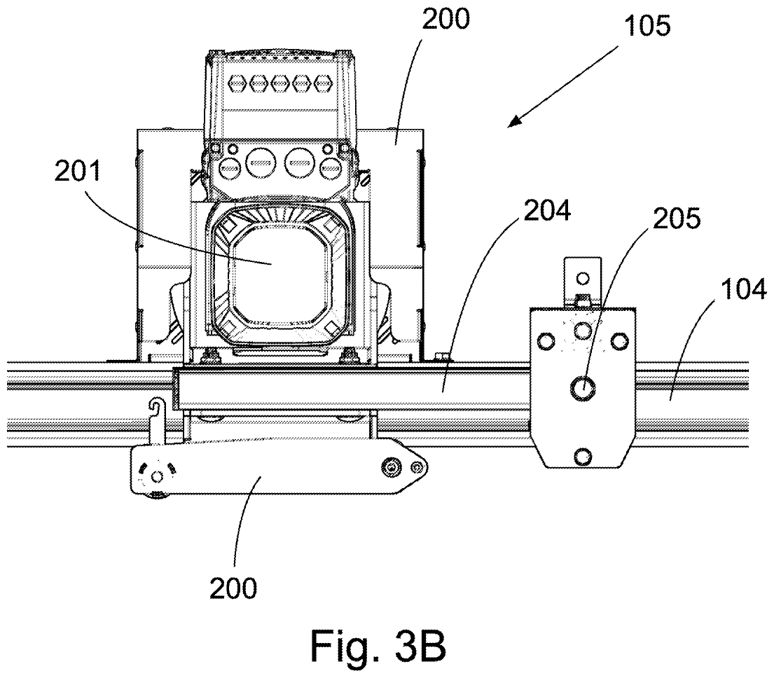

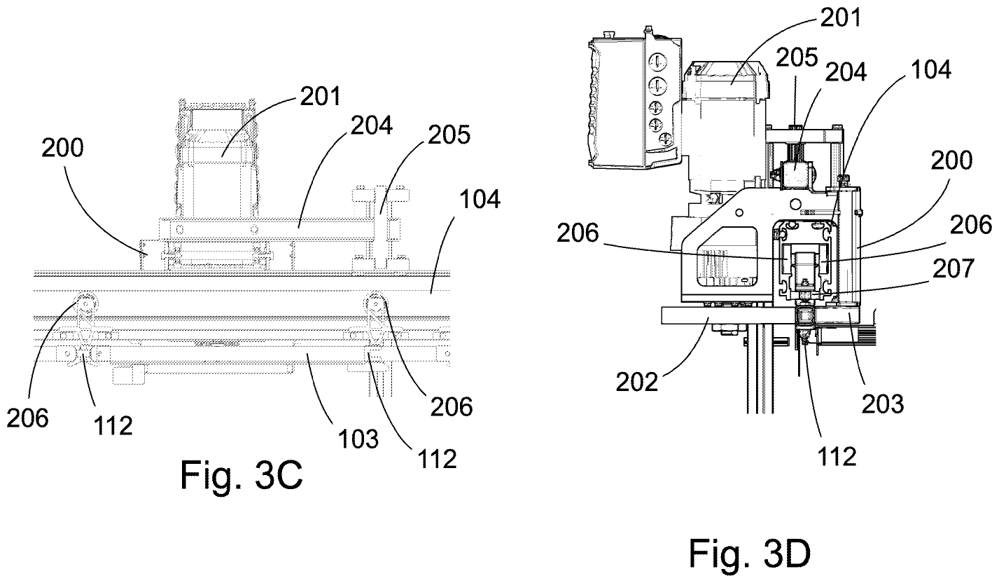

The driving system 102 comprises an array of concatenated driving rods 103 mutually hingedly connected. Each driving rod 103 is connected with a respective support assembly 101 at a first side of the support assembly 101 and is configured to follow a path defined by the orientation of a first guiding rail 104. To that end, the top end of each hinge shaft between each pair of driving rods 103 engage the first guiding rail 104, like curtain hanger engage a curtain rail, by means of guide wheels 206, 207 in an elongated profiled recess at the bottom side of the first guiding rail 104, as shown in FIGS. 3C and 3D.

Each of the support assemblies 101 comprises a wheel 106, on a second side opposite to the first side of the support assembly 101, to be guided by a second guiding rail 107 which is parallel to the first guiding rail 104.

The driving system further comprises an actuator 105, which in this embodiment is mounted on top of the first guiding rail 104. The array of concatenated driving rods 103, forming an endless chain, is driven by the actuator 105.

In this manner the driving system 102 and the guiding rails 104, 107 allow for horizontal movement of the support assemblies 101 along a transport direction T shown by an arrow in FIG. 1. Items 108 are received on top of the support assemblies 101 from a receiving section 109 and transported to one of a multitude of outlet section 110 along the path, where the items are pushed onto said outlet section 110 by a horizontal pusher means 111 of the support assembly 101.

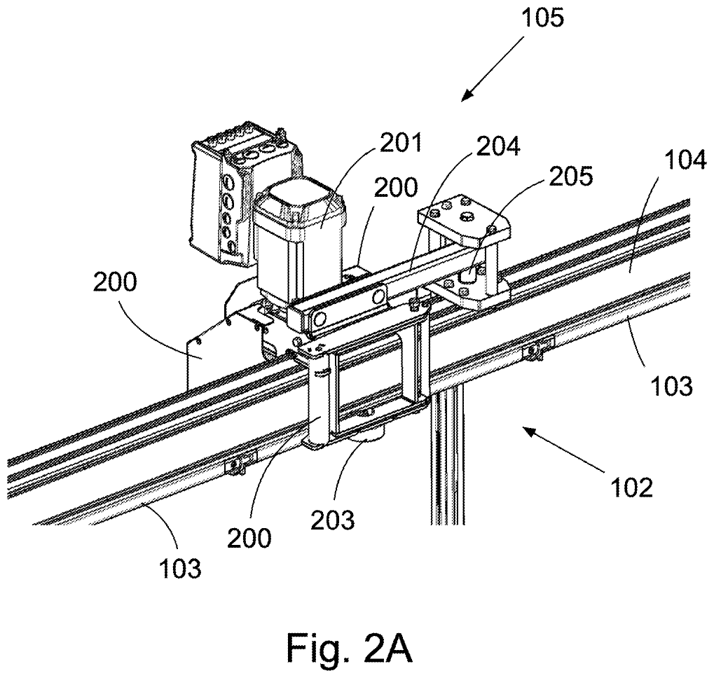

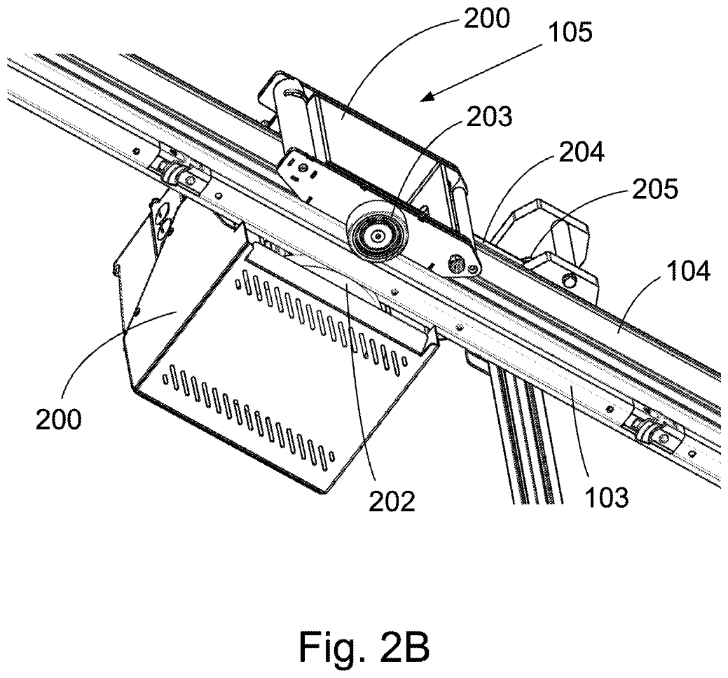

According to FIGS. 2 and 3 the actuator 105 comprises a frame 200 and a motor 201 with an output shaft on which a rotatable driving wheel 202 is mounted. The output shaft of the motor 201 extends transversely to the direction of movement of the rods 103 and the driving wheel 202 engages the rods 103 so that they are pushed in the transport direction T. The driving wheel 202 may have a rubber engaging surface.

In order to ensure that the driving wheel 202 will engage with the rods, a counter roller 203 is rotatably mounted on a shaft opposite the driving wheel 202, which engages the rods 103 at the opposite side of the driving wheel 202. The counter roller 203 may have a rubber engaging surface. The frame 200 with the driving wheel 202 and the counter roller 203 form a unit which engage and clamp the moving rods 103.

The actuator 105, comprising the frame 200, the motor 201, the driving wheel 202 and the counter roller 203, is movable substantially transversely to the transport direction T. The frame 200 is to that end connected to a link member 204 which extends from said frame 200 substantially parallel to the transport direction T, and the outer end of said link member 204 is connected to the first guiding rail 104 by means of a pivot member 205, such that the link member 204 with the actuator 105 can pivot about a pivot axis which is parallel to the axis of the output shaft of the motor 201.

As shown in FIGS. 3C and 3D, the top end of each hinge shaft 112 between each pair of driving rods 103 engage the first guiding rail 104, like curtain hanger engage a curtain rail, by means of guide wheels 206, 207 in an elongated profiled recess at the bottom side of the first guiding rail 104. The co-axial guide wheels 206 are mounted to the shaft 112 by means of a horizontal shaft and two pairs of respective guide surfaces of the profiled recess prevent vertical movement of the shaft 112. The guide wheel 207 is coaxially mounted on the shaft 112 and a pair of respective guide surfaces of the profiled recess prevent horizontal lateral movement of the shaft 112. The diameter of each guide wheel 206, 207 is slightly smaller than the distances between the respective pair of guide surfaces of the profiled recess that limit said movements, so that the wheels are not clamped between said pair of surfaces and allowed to roll against one of the surfaces of each pair.

The invention has thus been described by means of preferred embodiments. It is to be understood, however, that this disclosure is merely illustrative. Various details of the structure and function were presented, but changes made therein, to the full extent extended by the general meaning of the terms in which the appended claims are expressed, are understood to be within the principle of the present invention. The description and drawings shall be used to interpret the claims. The claims should not be interpreted as meaning that the extent of the protection sought is to be understood as that defined by the strict, literal meaning of the wording used in the claims, the description and drawings being employed only for the purpose of resolving an ambiguity found in the claims. For the purpose of determining the extent of protection sought by the claims, due account shall be taken of any element which is equivalent to an element specified therein. An element is to be considered equivalent to an element specified in the claims at least if said element performs substantially the same function in substantially the same way to yield substantially the same result as the element specified in the claims.

1. A conveyor system for transporting items from a receiving section to an outlet section, the conveyor system comprising:
an endless guiding rail which extends in a transport direction;
a plurality of support assemblies for carrying and transporting the items along said guiding rail;
a driving system for moving said plurality of support assemblies in said transport direction from the receiving section to the outlet section, wherein said driving system comprises:
an endless chain of concatenated driving rods which are hingably connected by means of a hinge shaft, and the hinge shaft between each pair of driving rods is mounted to said guiding rail in such a manner that said hinge shafts are allowed to move along said guiding rail and lateral movement of said hings shafts with respect to the guiding rail is restricted;
wherein each support assembly is connected to a respective rod to be moved thereby in the transport direction; and
an actuator connected to the guiding rail for moving said endless chain of concatenated driving rods in the transport direction, wherein said actuator comprises a frame with two wheels which engage said endless chain of concatenated driving rods between them, and wherein one of said wheels is a driving wheel driven by a motor; characterized in that said actuator comprising the frame and the wheels is mounted to the conveyor system in such a manner that it is movable substantially transversely to the transport direction.

2. The conveyor system of claim 1, wherein the frame is connected to a link member which extends from said frame substantially parallel to the transport direction, and the outer end of said link member is connected to the conveyor system by means of a pivot member, such that the link member with the actuator can pivot about a pivot axis which is parallel to the axis of rotation of the driving wheel.

3. The conveyor system of claim 2, wherein said pivot member is mounted on said guiding rail.

4. The conveyor system of claim 3, wherein the hinge shaft between each pair of driving rods is mounted to the first guiding rail at the bottom side of the first guiding rail.

5. The conveyor system of claim 4, wherein the top end of each hinge shaft between each pair of driving rods engage the guiding rail by means of guide wheels in an elongated profiled recess of the guiding rail.

6. The conveyor system of claim 5, wherein a guide wheel is coaxially mounted on the hinge shaft and a pair of respective guide surfaces of the profiled recess prevent horizontal lateral movement of the hinge shaft.

7. The conveyor system of claim 4, wherein the pivot member is mounted on top of the guiding rail.

8. The conveyor system of claim 7, wherein the movable actuator comprises the motor.

9. The conveyor system of claim 8, wherein the support assemblies each comprise a tray and a pusher element arranged on said tray to push items from the tray to the outlet section.
